(19) United States
(12) Patent Application Publication
(10) Pub. No.: US 2009/0217282 A1
(43) Pub. Date: Aug. 27, 2009

(54) PREDICTING CPU AVAILABILITY FOR SHORT TO MEDIUM TIME FRAMES ON TIME SHARED SYSTEMS

(76) Inventors: Vikram RAI, Franklin Park, NJ (US); Alok Srivastava, Newark, CA (US); Angelo Pruscino, Los Altos, CA (US); Sameer Joshi, San Jose, CA (US); Sunil Kumar, Foster City, CA (US); Sriram Sankaran, Bangalore (IN); Joy Mukherjee, Bangalore (IN)

Correspondence Address: HICKMAN PALERMO TRUONG & BECKER/ORACLE, 2055 GATEWAY PLACE, SUITE 550, SAN JOSE, CA, 95110-1083, US

(21) Appl. No.: 12/037,233

(22) Filed: Feb. 26, 2008

(51) Int. Cl. G06F 9/50

(52) U.S. Cl. 718/104

(57) ABSTRACT

A computer implemented CPU utilization prediction technique is provided. CPU utilization prediction is implemented described in continuous time as an auto-regressive process of the first order. The technique used the inherent autocorrelation between successive CPU measurements. A specific auto-regression equation for predicting CPU utilization is provided. CPU utilization prediction is used in a computer cluster environment. In an implementation, CPU utilization percentage values are used by a scheduler service to manage workload or the distribution of requests over a vast number of CPUs.

### FIELD OF THE INVENTION

The present invention relates availability of a computer processing unit for processing. In particular, embodiments of the present invention relate to applying time series auto-regression techniques for predicting utilization percentages or availability of a computer processing unit.

### BACKGROUND OF THE INVENTION

Cluster computing entails the deployment of a single application across a cluster of servers. For example, a resource intensive database application can be distributed across a cluster of computer processing units (CPUs). Typically, the distributed execution of the resource intensive application is scheduled across one or more servers of the cluster of servers. Furthermore, the distributed application typically requires critical response times.

It should be appreciated that the performance characteristics of most applications vary dynamically. For example, at one time the performance of an application may require a large utilization percentage of a particular CPU. While, at another time, the performance of an application may require a small percentage of the CPU.

As well, the sharing of a CPU among two or more applications directly causes the deliverability of the performance of the CPU to vary over time.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram depicting a computer cluster and a scheduling service, with which an embodiment may be used;

FIGS. 2a-2c are flow diagrams showing a process flow for predicting CPU utilization percentage according to an embodiment; and

FIG. 3 is a block diagram of a computer system on which embodiments may be implemented.

### DETAILED DESCRIPTION OF THE INVENTION

A method and system are described for predicting utilization of or, alternatively, availability of, a computer processing unit (CPU). In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In an embodiment, CPU availability is modeled as a partly stochastic process. As well, the availability of the CPU in the near term can be predicted. Mean reversion is a tendency for a stochastic process to remain near, or tend to return over time to, a long-run average value. It should be appreciated that, in a natural way, the stochastic process representing CPU availability is a mean-reverting process. Hence, because CPU availability is a mean-reverting process, it is not possible for CPU utilization or, alternatively, CPU availability to be expressed as one or more monotonically increasing or decreasing functions.

A correlation is the mutual relationship between two or more random variables. Autocorrelation is the correlation of a signal with itself. Determining the autocorrelation of a signal can be useful in finding repeating patterns in the signal. For example, by applying autocorrelation techniques, the presence of a periodic signal can be determined. The autocorrelation of a signal can also be described as the correlation of a process against a time-shifted version of the process.

Hence, in an embodiment, CPU utilization is modeled as an auto-regressive process of the first order in continuous time. Such modeling of CPU utilization utilizes an autocorrelation between successive CPU measurements that is naturally inherent. A degree of self-similarity can be determined from modeling CPU utilization as an auto-regressive process of the first order in continuous time. The degree of self-similarity can be referred to as a kind of dependence. As well, such modeling of CPU utilization can demonstrate how such dependence is manifested in the short and medium term predictability of CPU resources.

### An Exemplary CPU Availability Prediction Technique

In an embodiment, available CPU percentage, i.e. a percentage of CPU time that could be available to a computer process, is computed using a load average measurement. An exemplary load average measurement utility is vmstat. vmstat is a utility program that is part of a UNIX system that outputs various virtual memory statistics. However, it should be appreciated that any other such utility known to one skilled in the art can also be used.

### Derivation of CPU Availability Equation.

Consider the equation:

C_{t+dt}=Cₜ+dC; Eq. 1.1

In Eq. 1.1, Cₜ represents CPU availability at time t. dt represents an incremental passage of time. It should be appreciated that by using dt, the continuous time process representing CPU availability becomes discretized. dC represents an incremental increase in CPU availability.

Eq. 1.1 can be written as:

C_{t+dt}=Cₜ+(η−γ*Cₜ)*dt+ν*dX_{t+dt}; Eq. 1.2

In Eq. 1.2, the term, (η−γ*C)*dt, denotes the drift of available CPU and is a predictable element. As well in Eq. 1.2, the term, ν*dX_{t+dt}, denotes the diffusion of available CPU and is a stochastic element. Upon expanding terms and rearranging terms, Eq. 1.2 can be rewritten as:

C_{t+dt}=η*dt+(1−γ*dt)*Cₜ+ν*dX_{t+dt}; Eq. 1.3

It should be appreciated that to predict parameters η, ν, and γ, Eq. 1.3 can be transformed into a equation expressing a regression of the form:

C_{t+dt}=α+β*Cₜ+εₜ˜N(0, σ²) where εₜ is the error term; Eq. 1.4

It should be appreciated that ε_{t+dt} has variance σ² and not 1. Thus, ε_{t+dt} can be obtained from the standard normal distribution, i.e. with variance 1 and by using the scaling (σ)^{1/2}.

Thus,

α=η*dt;

β=(1−γ*dt);

Variance (ν*dX_{t+dt})=ν2*dt; and

ν2*dt=σ2.

The parameters α and β can be found by an Ordinary Least Squares (OLS) method. In an embodiment, the OLS estimates are:

β=Σ(Cₜ−Cₘₑₐₙ)(C_{t+dt}−C_{t+dt(mean)})/Σ(Cₜ−Cₘₑₐₙ)²; and

α=C_{t+dt(mean)}−β*Cₘₑₐₙ,

where:

Cₘₑₐₙ=1/n*Σ Cₜ, and

C_{t+dt mean}=1/n*Σ C_{t+dt}.

Finally, to estimate the standard error of the error term, in an embodiment, compute the sample standard errors, as follows:

εₜ=C_{t+dt}−α−β*Cₜ; and

σ=(1/(n−2)Σ εₜ²)^{1/2}.

It should be appreciated that a CPU utilization percentage has the following relationship with CPU availability:

CPU utilization percentage=1−(CPU availability).

Thus, to determine a CPU utilization percentage is sufficient to determine the related CPU availability percentage. Hence, to discuss aspects of deriving CPU utilization percentages is effectively sufficient to understanding the related aspects of deriving CPU availability.

In an embodiment, the parameters, α and β and the standard errors are updated by recalculating the parameters and the standard errors based on updated data points. For example, the updated data points can include previous data and newly measured data.

It should be appreciated that predictions generated by subsequent measurements can be compared with predictions generated by prior measurements to understand the error involved in the process of prediction, also referred to as forecasting. Thus, it is possible to use a sliding window over previous measurements to compute a one-step-ahead forecast based on either some estimate of the mean or median of those measurements.

### Estimating Regression Parameters

Following is a description of an example approach for estimating the regression parameters, α, β, εₜ and σ. In this example approach, assume 20,000 observations for CPU utilization percentages, or 20,000 data points, are captured. Let each data point be denoted by Cₜ, where each observation is taken at uniform intervals. Applying the concept of auto-regression, regress C_{t+dt} on Cₜ. Thus, in an embodiment, samples 1-19,999 are treated as the independent variable, Cₜ, and samples 2-20,000 are treated as the dependent variable, Cₜ₊₁.

Hence, Cₘₑₐₙ=1/n*Σ Cₜ and C_{t+1 mean}=1/n*Σ Cₜ₊₁ can be determined from applying samples 1-19,999 and samples 2-20,000, respectively. Thus, α and β can be determined using the OLS estimates. Then, εₜ and σ are determined.

It should be appreciated that, after a predetermined amount of time, the parameters of the regression equation can be updated. For example, after a predetermined amount of time, α, β, εₜ, and σ can be recalculated based on the previous 20,000 observations plus new measurements of CPU utilization percentages.

### Example Implementation Using the Estimated Regression Parameters

Distributed applications operating across computer clusters can be very resource intensive. Thus it is desirable for resources, such as the CPU, to be shared. It has been found that results from sharing a particular CPU can cause the deliverable performance of the particular CPU to vary over time. Hence, the prediction of the particular CPU availability can be helpful to a type of scheduler. For instance, predicting CPU availability can allow a scheduler to make the best use of each individual CPUs that are at hand at any given point in time. For example, predicting CPU availability can be incorporated in an automated application scheduler for the purpose of building dynamic schedulers.

In another example, suppose an automated application scheduler receives a request for CPU usage. Suppose that the regression parameters, α and β and the standard errors, εₜ and σ, have been previously determined. Suppose further that the CPU usage from the last time interval is known. Then, the automated application scheduler can compute a predicted value of usage of the CPU by using the known parameters, the latest known CPU usage amount, and the regression equation, Eq. 1.4, to compute a predicted usage for the CPU at the next time interval. As well, using these parameters and the latest known CPU usage for a given CPU, the automated application schedule can compute a predicted value of usage for every CPU in the cluster of CPUs. Further, if the predicted usage of a particular CPU is a value that indicates the particular CPU is not available, i.e. is full, then the automated application scheduler can forward the request for usage to another CPU in the cluster where the other CPU in the cluster had a CPU usage value that indicated it could handle the request. Hence, the workload for a given cluster of CPUs can be assessed based on the predicted values of individual CPU usage.

### Example Computer Cluster

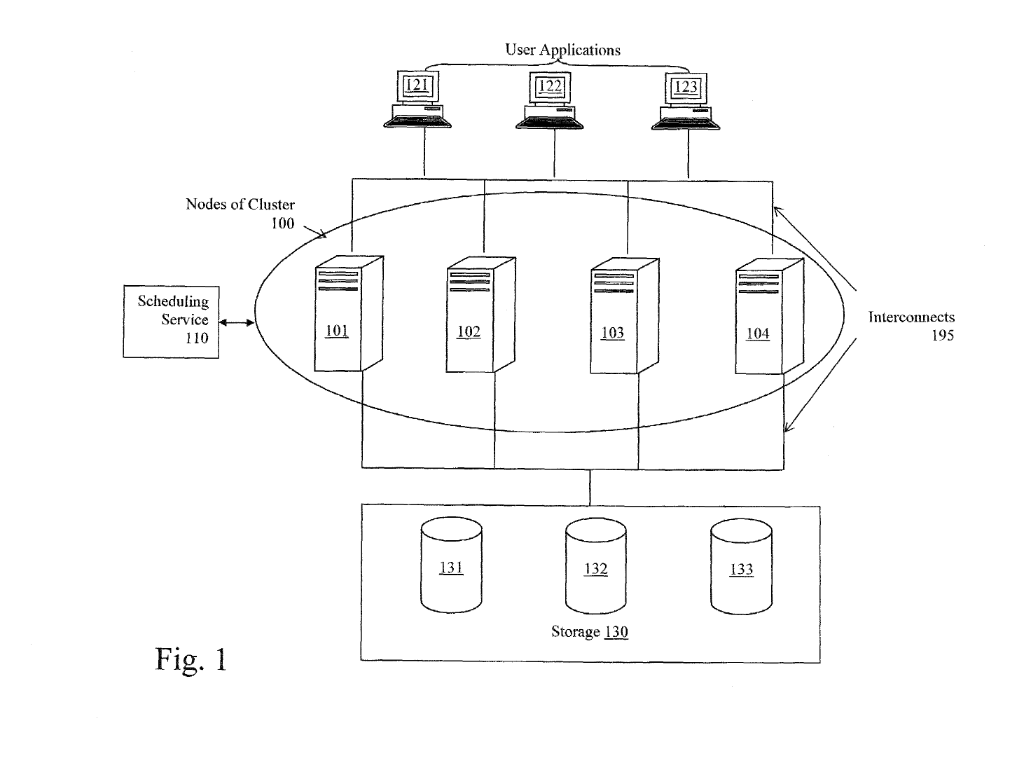

FIG. 1 depicts an example computer cluster 100, according to an embodiment. Cluster 100 comprises computers, or CPUs, 101, 102, 103 and 104 that are interconnected to support multiple distributed applications 121, 122 and 123. The computers 101-104 of cluster 100 are networked with interconnects 195, which can comprise a hub and switching fabric, a network, which can include one or more of a local area network (LAN), a wide area network (WAN), an inter-network (which can include the Internet), and wire line based and/or wireless transmission media. While four computers are shown in the example depicted in FIG. 1, it should be appreciated that any number of computers can be interconnected as nodes of cluster 100. The four computers shown are depicted by way of illustration, description and simplification only and in no way by limitation.

In an embodiment, computers 101-104 may be configured as clustered database servers. So configured, cluster 100 can implement a real application cluster (RAC), such as are available commercially from Oracle™ Corp., a corporation in Redwood Shores, Calif. Such RAC clustered database servers can implement a foundation for enterprise grid computing and/or other solutions capable of high availability, reliability, flexibility and/or scalability. It should be appreciated that example RAC 100 is depicted by way of illustration only and not by limitation.

Cluster 100 interconnects the distributed applications 121-122 to information storage 130, which includes example volumes 131, 132 and 133. Storage 130 can include any number of volumes. Storage 130 can be implemented as a storage area network (SAN), a network area storage (NAS) and/or another storage modality.

In the embodiment, scheduling service 110 stores and implements the inventive auto-regression algorithm described herein. Hence, scheduling service 110 facilitates a performance-oriented distributed software infrastructure. Scheduling service 110 predicts workload values for each computer and distributes requests among computers in cluster 100 accordingly. It should be appreciated that such performance-oriented distributed software infrastructure enables seamless integration of a vast collection of CPUs into computational grids. That is, because the embodiment enables scheduling resource-intensive requests for usage across clusters of CPUs, such embodiment can be applied to any distributed computing application.

### Example Process Flow

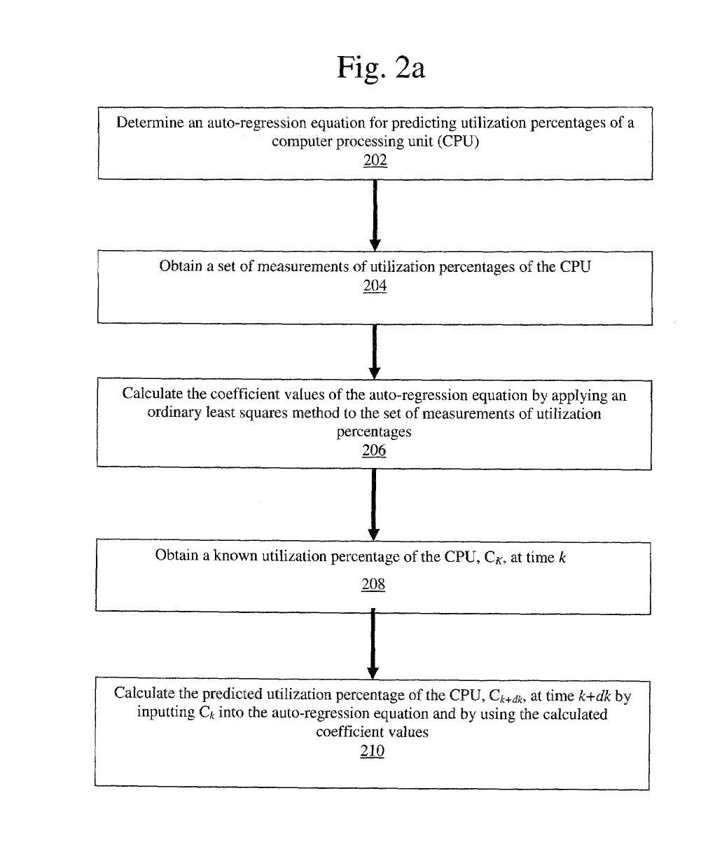

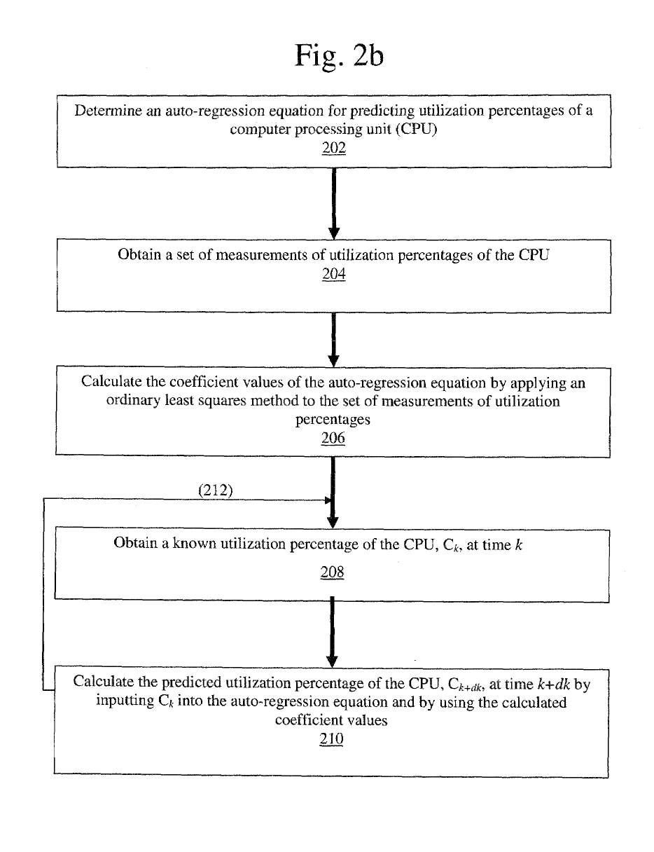

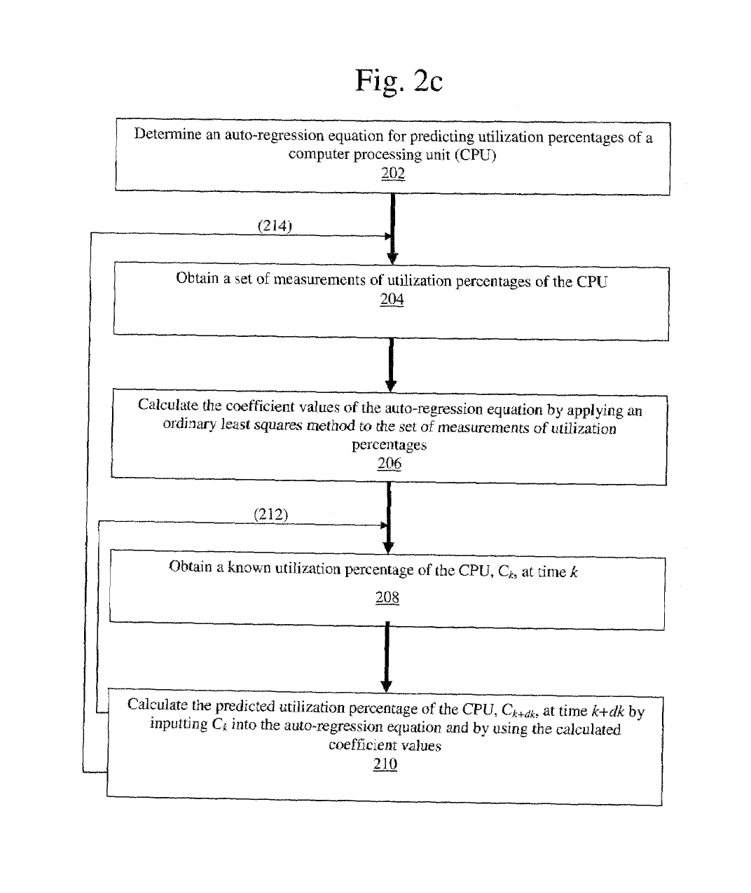

An example process flow of the predicting CPU utilization percentage can be described with reference to FIG. 2a. An auto-regression equation for predicting utilization percentages of a computer processing unit (CPU) is determined (202). Utilization percentages of the CPU are measured or obtained (204) to create a history of utilization percentages for the particular CPU. Using the history of utilization percentages of the CPU, coefficient values of the auto-regression equation are derived. Specifically, the coefficient values of the auto-regression equation are derived by applying ordinary least squares to the set of measurements of utilization percentages (206). Given, or obtaining, a known utilization percentage of the CPU at a time k, Cₖ (208), the utilization percentage of the CPU at time k+dk, C_{k+dk}, is calculated. Specifically, C_{k+dk} is calculated by inputting Cₖ into the auto-regression equation and by using the calculated coefficient values (210).

FIG. 2b is FIG. 2a with a loop (212). Loop (212) illustrates that the same auto-regression equation and the same obtained coefficient values in FIG. 2a can be used repeatedly to predict a next utilization percentage of the CPU. That is, at any time k and given the known utilization percentage of the CPU at time k, Cₖ, the utilization percentage of the CPU at a time k+dk, C_{k+dk}, is calculated.

FIG. 2c is FIG. 2b with a new loop (214). Loop (214) illustrates that the process allows for the coefficient values to be updated as desired at a later point in time. That is, at a later point in time, as indicated by loop (214), a new set of measurements of utilization percentages of the CPU is obtained (204). For instance, the new set of measurements can include the same set of measurements obtained the previous time as well as any new measurements of utilization percentages of the CPU since the previous time. From the new set of measurements, new coefficient values are calculated (206). The new coefficient values can be used for predicting a next utilization percentage of CPU as long as desired or until a new update is desired. Thus, the process allows for calculating updated coefficient values which more accurately reflect changes of CPU usage over time.

### Hardware Overview

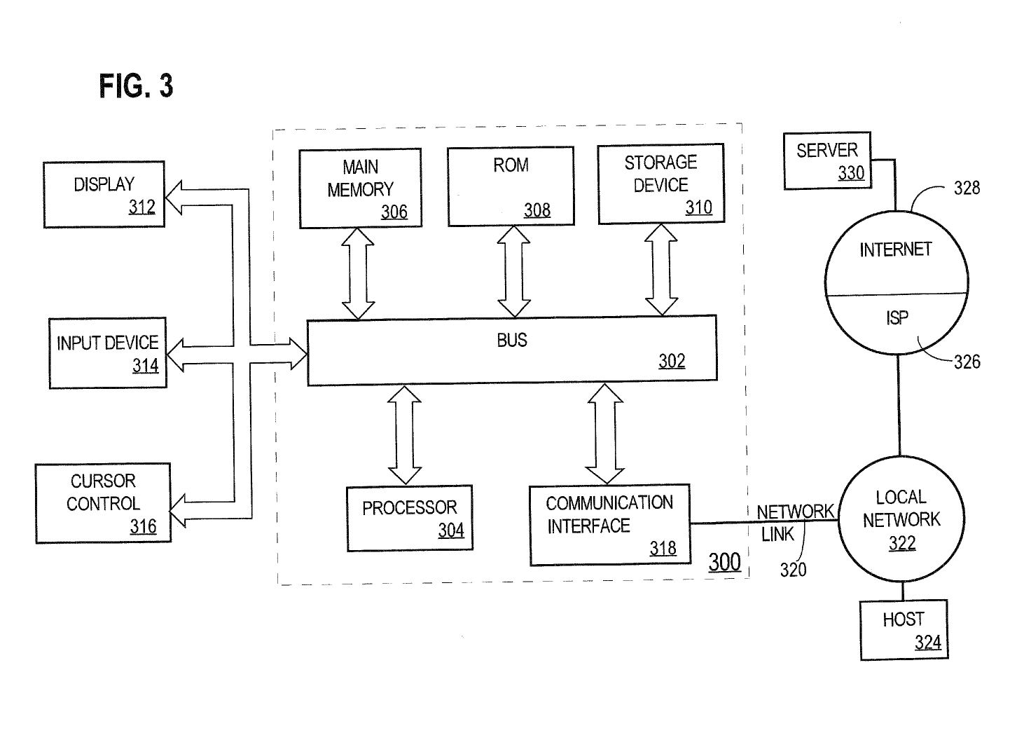

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The claimed subject matter is related to the use of computer system 300 for predicting CPU usage or availability. According to one embodiment, for predicting CPU usage or availability is provided by computer system 300 in response to processor 304 executing one or more sequences of one or more instructions contained in main memory 306. Such instructions may be read into main memory 306 from another computer-readable medium, such as storage device 310. Execution of the sequences of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infrared transmitter to convert the data to an infrared signal. An infrared detector coupled to bus 302 can receive the data carried in the infrared signal and place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the worldwide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318. In accordance with an embodiment, one such downloaded application provides for predicting CPU usage or availability as described herein.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer implemented method comprising:
determining an auto-regression process for predicting utilization percentages of a computer processing unit (CPU);
obtaining a set of measurements of utilization percentages of the CPU wherein the each measurement is taken at a time interval of a first series of time intervals;
calculating one or more coefficient values of the auto-regression process by using the set of measurements of utilization percentages;
obtaining a known utilization percentage of the CPU, Cₖ, at a time k; and
calculating a predicted utilization percentage of the CPU, C_{k+dk}, at a time that is dk amount of time added to time k, by inputting the known utilization percentage of the CPU, Cₖ, into the auto-regression process and by using the calculated one or more coefficient values.

2. The computer implemented method of claim 1, wherein CPU availability at time k is determined from the relationship, 1−C_{k+dk}.

3. The computer implemented method of claim 1, wherein:
determining the auto-regression process comprises using auto-regressing equation,
C_{t+dt}=α+β*Cₜ+εₜ3 N(0, σ²) wherein ε is the error term;
the obtained set of measurements of utilization percentages of the CPU contains n ordered measurements;
calculating the coefficient values, α and β, of the auto-regression equation comprises using ordinary least squares on the set of n measurements, as follows:
β=Σ(Cₜ−Cₘₑₐₙ)(C_{t+dt}−C_{t+dt(mean)})/Σ(Cₜ−Cₘₑₐₙ)²; and
α=C_{t+dt(mean)}−β*Cₘₑₐₙ,
where:
Cₘₑₐₙ=1/n*Σ Cₜ, and
C_{t+dt mean}=1/n*Σ C_{t+dt},
εₜ=C_{t+dt}−α−β*Cₜ, and
σ=(1/(n−2)Σ εₜ²)^{1/2}.

4. The computer implemented method of claim 1, further comprising:
recalculating α, β, εₜ, and σ using the obtained set of measurements of utilization percentages of the CPU plus additional CPU measurements that were measured over a second series of time intervals that occurred after the first series of time intervals.

5. The computer implemented method of claim 1, wherein obtaining the set of measurements of utilization percentages of the CPU further comprises using a load average measurement utility.

6. The computer implemented method of claim 1, wherein the CPU is one of a plurality of CPUs in a computer cluster.

7. The computer implemented method of claim 6, further comprising:
receiving a request to use the CPU;
wherein the predicted utilization percentage of the CPU indicates that the CPU is not available to handle the request; and
finding a second CPU of the plurality of CPUs that has a predicted utilization percentage indicating that the second CPU is available to handle the request;
sending the request to the second CPU; and
said second CPU handling the request.

8. The computer implemented method of claim 4, wherein the intervals of the first series of time intervals are uniformly distributed or the intervals of the second series of time intervals are uniformly distributed.

9. The computer implemented method of claim 3, wherein
creating a first dataset from the n ordered measurements by populating the first dataset with the first element of the n ordered measurements through the (n−1)^{th} element of the n ordered measurements;
creating a second dataset from the n ordered measurements by populating the second dataset with the second element of the n ordered measurements through the n^{th} element of the n ordered measurements; and
assigning the elements of the first dataset to be independent variables (Cₜ) and assigning the elements of the second dataset to be dependent variables (C_{t+dt}), where t=1,n and dt is a next interval occurring after the last interval in the first series of time intervals.

10. A computer-readable storage medium bearing instructions for performing the steps of:
determining an auto-regression process for predicting utilization percentages of a computer processing unit (CPU);
obtaining a set of measurements of utilization percentages of the CPU wherein the each measurement is taken at a time interval of a first series of time intervals;
calculating one or more coefficient values of the auto-regression process by using the set of measurements of utilization percentages;
obtaining a known utilization percentage of the CPU, Cₖ, at a time k; and
calculating a predicted utilization percentage of the CPU, C_{k+dk}, at a time that is dk amount of time added to time k, by inputting the known utilization percentage of the CPU, Cₖ, into the auto-regression process and by using the calculated one or more coefficient values.

11. The computer-readable storage medium of claim 10, wherein CPU availability at time k is determined from the relationship, 1−C_{k+dk}.

12. The computer-readable storage medium of claim 10, wherein:
determining the auto-regression process comprises using auto-regressing equation,
C_{t+dt}=α+β*Cₜ+εₜ3 N(0, σ²) wherein σ is the error term;
the obtained set of measurements of utilization percentages of the CPU contains n ordered measurements;
calculating the coefficient values, α and β, of the auto-regression equation comprises using ordinary least squares on the set of n measurements, as follows:
β=Σ(Cₜ−Cₘₑₐₙ)(C_{t+dt}−C_{t+dt(mean)})/Σ(Cₜ−Cₘₑₐₙ)²; and
α=C_{t+dt(mean)}−β*Cₘₑₐₙ,
where:
Cₘₑₐₙ=1/n*Σ Cₜ, and
C_{t+dt mean}=1/n*Σ C_{t+dt}, and where:
εₜ=C_{t+dt}−α−β*Cₜ, and
σ=(1/(n−2)Σ εₜ²)^{1/2}.

13. The computer-readable storage medium of claim 10, further comprising the step of:
recalculating α, β, εₜ, and σ using the obtained set of measurements of utilization percentages of the CPU plus additional CPU measurements that were measured over a second series of time intervals that occurred after the first series of time intervals.

14. The computer-readable storage medium of claim 10, wherein obtaining the set of measurements of utilization percentages of the CPU further comprises using a load average measurement utility.

15. The computer-readable storage medium of claim 10, wherein the CPU is one of a plurality of CPUs in a computer cluster.

16. The computer-readable storage medium of claim 15, further comprising the steps of:
receiving a request to use the CPU;
wherein the predicted utilization percentage of the CPU indicates that the CPU is not available to handle the request; and
finding a second CPU of the plurality of CPUs that has a predicted utilization percentage indicating that the second CPU is available to handle the request;
sending the request to the second CPU; and
said second CPU handling the request.

17. The computer-readable storage medium of claim 13, wherein the intervals of the first series of time intervals are uniformly distributed or the intervals of the second series of time intervals are uniformly distributed.

18. The computer-readable storage medium of claim 12, wherein
creating a first dataset from the n ordered measurements by populating the first dataset with the first element of the n ordered measurements through the (n−1)^{th} element of the n ordered measurements;
creating a second dataset from the n ordered measurements by populating the second dataset with the second element of the n ordered measurements through the n^{th} element of the n ordered measurements; and
assigning the elements of the first dataset to be independent variables (Cₜ) and assigning the elements of the second dataset to be dependent variables (C_{t+dt}), where t=1,n and dt is a next interval occurring after the last interval in the first series of time intervals.
